(19) United States
(12) Patent Application Publication
(10) Pub. No.: US 2016/0178778 A1
(43) Pub. Date: Jun. 23, 2016

(54) METHOD OF ACOUSTIC WELL LOGGING

(71) Applicant: SCHLUMBERBER TECHNOLOGY CORPORATION, Sugar Land, TX (US)

(72) Inventor: Dmitry Belov, Sagahihara-shi (JP)

(21) Appl. No.: 14/974,934

(22) Filed: Dec. 18, 2015

(30) Foreign Application Priority Data
Dec. 19, 2014 (RU) 2014151467

(51) Int. Cl. G01V 1/44; E21B 47/14

(52) U.S. Cl. CPC G01V 1/44; E21B 47/14

(57) ABSTRACT

Methods for acoustic logging are described herein. The method includes disposing an acoustic logging tool in a wellbore. The tool includes at least one directional acoustic signal source and at least one acoustic signal receiver. A position of the tool in the wellbore and/or a wellbore shape are determined at each step of acoustic logging before acoustic measurements are taken. A required direction of acoustic signal emission is determined, then an angle of rotation of the logging tool around its axis is computed to provide the determined direction. The acoustic signal source is rotated by the computed angle and acoustic measurements are taken.

### CROSS-REFERENCE TO RELATED APPLICATION

This application claims priority to Russian Application No. 2014151467 filed Dec. 19, 2014, which is incorporated herein by reference in its entirety.

### BACKGROUND

The invention relates to geophysical surveys, in particular, to acoustic well logging.

Acoustic well logging is one of the methods used in field practice for acoustic well-logging measurements. In an acoustic well logging operation, a transmitter is used to emit elastic oscillations which propagate in the wellbore fluids and surrounding rocks and are detected by acoustic receivers placed in the same wellbore. Generally, acoustic well logging is performed using downhole logging tools to determine travel times of the key types of waves as the acoustic energy travels in the formation rock from the transmitter to the receiver array. Data acquired during such surveys allow geoscientists to create geo-acoustic models of well sections for seismic data interpretation, determine rock elasticity moduli, evaluate rock porosity, etc. Quality of acoustic data provided by acoustic well logging tools depends on many factors, such as position of a logging tool in a wellbore, wellbore shape, signal source type, etc. The position of a logging tool in a wellbore is especially critical for logging tools with directional sources, i.e. sources with pre-determined signal propagation direction according to a polar pattern. In this case, the polar pattern of an acoustic signal source pressure field (as applied to sources emitting in liquid media, i.e. in media present in the wellbore) means the dependence of pressure amplitude provided by the source from angular coordinates and an observation point in horizontal and/or vertical planes. Such sources, for example, include dipole or quadrupole acoustic sources used in logging tools designed to determine rock anisotropy along the wellbore.

Some problems may be encountered with tool orientation in a non-cylindrical well. For non-cylindrical wells, characteristics of dispersion curves (acoustic velocity vs frequency curves) plotted during analysis of downhole acoustic field measurements depend on source characteristics and, particularly, on a directional pattern of the signal source in the case of a directional source (because under certain downhole conditions it is impossible to produce a full spectrum of oscillations). In some cases, a combination of wellbore geometry with error in choosing the signal direction of a directional source can result in poor quality of the acoustic data.

To avoid tool eccentricity (when a tool is off center to the well axis), special devices are typically run in the well, such as different types of centralizers (see, for example, Budyko L. V. “Centering of logging tools in uncased wells”, NTV “Karotazhnik”, Tver, Publishing house AIS, 2002, Issue 95, p. 2638). But in some cases (for example, if the hole has diameters of different shapes and sizes or if the wellbore is deviated), centralizers are not quite efficient for eliminating acoustic tool eccentricity. Such eccentricity results in inferior quality of the acoustic data received from the tool. Tool eccentricity, for example, caused by missing or broken centralizers or high deviation angle making the tool weight compress centralizer springs, may result in generation of double-humped waves identified when the acoustic data are processed. It results in incorrect calculation of travel time because the acquisition system identifies different local peaks when seeking the maxima of waves (see Stenin A. V., A Comprehensive Technology for Processing and Interpretation of Data from Multi-Channel Acoustic System During Oil and Gas Well Logging, Abstract of Thesis for Science Candidate Degree, UDK 550.83.05, Moscow, 2009). Another problem with using such data for accurate plotting of dispersion curves, which is especially true for medium and high frequency bands (about 1000 Hz and higher) for high-velocity rocks. Here, dispersion curves mean dependency between phase and wave group velocity of normal waves and frequency of the wave process. (see H. D. Leslie, C. J. Randall, Eccentric Dipole Sources in Fluid-Filled Wellbore: Numerical and Experimental Results, Journal of the Acoustical Society of America 87(6):2405 (1990) and H Joongmoo Byun, M. Nafi Toksöz, Effects of an Off-Centered Tool on Dipole and Quadrupole Logging, GEOPHYSICS,VOL. 71, NO. 4 JULY-AUGUST 2006; P. F91-F100.).

### SUMMARY

In various embodiments, the proposed method provides for an improved quality of data acquired during acoustic logging with significant eccentricity of a logging tool in a wellbore and/or when applied in wells with non-cylindrical shape by adjusting the direction of signal from a directional signal source.

According to one embodiment of the method, a movable acoustic logging tool is disposed in a wellbore. The acoustic logging tool includes at least one directional acoustic signal source and at least one acoustic signal receiver. A position of the tool in the wellbore and/or wellbore shape are determined at each step of acoustic logging before acoustic measurements are taken. A required direction of acoustic signal emission is determined, then an angle of rotation of the logging tool around its axis is computed to provide the determined direction. Then, the acoustic signal source is rotated by the computed angle and acoustic measurements are taken.

The position of the acoustic logging tool in the wellbore and the shape of the wellbore can be determined by measurements taken by sensors. For example, these can be ultrasonic or optoelectronic sensors capable of measuring a distance between a tool body and wellbore walls.

### BRIEF DESCRIPTION OF DRAWINGS

Those skilled in the art should more fully appreciate advantages of various embodiments of the present disclosure from the following “Description of Illustrative Embodiments,” discussed with reference to the drawings summarized immediately below.

FIG. 1 shows a wellbore drilled in a rock with an acoustic logging tool being off center of an axis of the wellbore;

FIG. 2 shows dispersion curves plotted for a dipole signal source with a directional pattern “Direction 1”; and

FIG. 3 shows dispersion curves plotted for a dipole signal source with a directional pattern “Direction 2”.

### DETAILED DESCRIPTION

Rotation of a directional acoustic signal source around a main axis of an acoustic logging tool to a specified angle allows the signal source to emit acoustic signal in a required direction when the acoustic logging tool has a significant eccentricity relative to the wellbore axis, as well as for non-cylindrical wells, or for a combination of these conditions.

Non-cylindrical wells are wells with any shapes of cross-section which differ from the cylindrical cross-section (due to specifics of drilling process, properties of rocks around the wellbore, etc.). Characteristics of dispersion curves (acoustic velocity vs frequency curves) for such wells, plotted during analysis of downhole acoustic field measurements, depend on source characteristics and, particularly, on directional pattern of the signal source in the case of a directional source (because under certain downhole conditions it is impossible to produce a full spectrum of oscillations). In some cases, a combination of wellbore geometry and error in choosing the signal direction of a directional source can result in poor quality of the acoustic data.

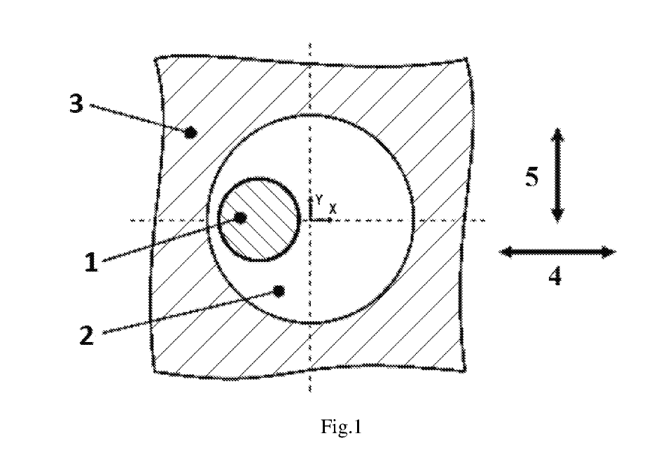

FIG. 1 shows an acoustic logging tool 1 positioned in a wellbore 2, which is drilled in the rock 3, where the main axis of the acoustic logging tool does not match the wellbore axis, e.g. the logging tool has some eccentricity. Different directions of acoustic signal in this case result in different dispersion curves. FIG. 1 shows the first direction (“Direction 1”) 4 of the dipole acoustic signal source directional pattern, and the second direction (“Direction 2) 5 of the dipole acoustic signal source directional pattern. Eccentricity can be caused by imperfect methods of tool centralization in the well, sharp changes in wellbore geometry and other factors. For example, a technical paper by Denis P. Schmitt, Dipole Logging in Cased Boreholes, J. Acoust. Soc. Am., Vol. 93, No 2, February 2013, P. 640-657, highlights that in a severely deviated or horizontal well, where acoustic logging tool cannot be effectively centralized, reliable measurements are still possible, provided that the direction of the directional signal source is normal to the direction of eccentricity.

The following is proposed in order to achieve acquisition of high-quality acoustic data for acoustic logging with off-center logging tools and for acoustic logging in non-cylindrical wells.

At each step of logging (between acoustic field measurements), data are collected about a position of the logging tool and/or a borehole shape. Such information can be obtained either by measurements taken with a specialized sensors (which can be installed on the acoustic logging tool) or analyzing the current acoustic measurements, or by any other methods. Using a measurement device with such sensors as part of the acoustic logging tool is described in Jennifer Market, Chris Bilby, Introducing the First LWD Crossed-Dipole Sonic Imaging Service, SPWLA 52^{nd} Annual Logging Symposium, May 14-18, 2011. A description of such a device can be found in U.S. Patent Application Publication No. 2006/0070433, published on Apr. 6, 2006 by Fredette et al, which is hereby incorporated by reference herein in its entirety. Ultrasonic sensors for such measurements can be sensors made by Microsonic GmbH of Germany (http ://www.microsonic.de/en/Products/overview.htm?O=4&gclid=CIi3-bkQtsICFVUMjgod0qIAKQ).

The acquired information is analyzed (automatically, by an operator or by any other method) and a required direction(s) for emitting directional signal(s) (based on any specified criteria) is computed and a required angle(s) of rotation of the acoustic signal source(s) around the axis of the acoustic signal source is specified for providing the required direction(s). Any algorithm can be used to determine the required direction. As one of such algorithms, it is proposed to compare the current configuration of the system (position of the logging tool downhole, borehole shape, etc.) with that stored in a pre-defined database. It is recommended to pre-define any possible system configurations in the database (including well diameter, type of the logging tool, etc.) and the required signal emission directions for the acoustic signal source(s). Such directions can be obtained from theoretical estimates, from numerical modeling or by any other methods. In a broader sense, the term “required direction” means such signal direction of the directional signal source which allows a widest possible spectrum of oscillations to be generated in the well. In addition, provisions are made for a specific case when, for example, only S-waves must be generated in a well. The signal emission direction of a directional source which allows only such waves to be generated is also covered by the term “required direction”. In each specific case, choice of an optimum direction depends on what type of waves should be measured by the acoustic logging tool, i.e. what type of oscillations should be generated in the well.

The acoustic signal source is rotated by the required angle, an acoustic signal is emitted, then acoustic field measurements are taken.

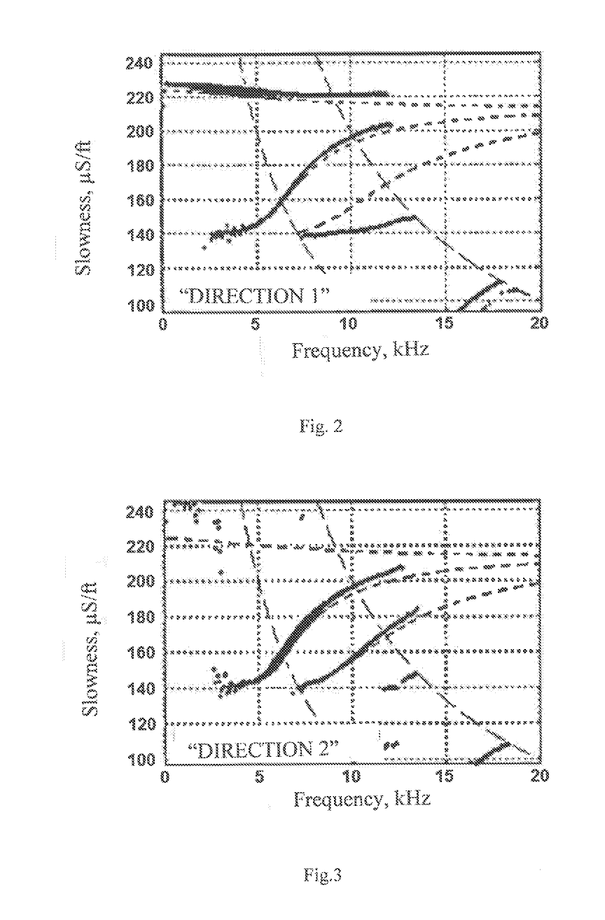

Below is an example of operation of a logging tool with a dipole acoustic signal source installed in a wellbore. The algorithm is as follows:
i. The tool is moved into the current position in the wellbore.
ii. Tool sensors measure current position of the tool relative to the well main axis. The tool sensors can be, for example, ultrasonic sensors. In this case, sensors are installed as part of the single tool assembly around the tool axis at certain angle increments (for example, 90 degrees (4 sensors) or 60 degrees (6 sensors)). The sensors emit ultrasonic signals in synchronism and immediately switched into receiving more to record the signals reflected from the walls. Difference in arrivals of reflected waves is used to determine tool position in the well. Optoelectronic sensors can be used as an alternative solution (for example, http://www.balluffru/pdf/bos/BOD_63M.pdf). Constant propagation speed of electromagnetic radiation allows for measuring distance to an object. In this case, sensors are installed as part of the single tool assembly around the tool axis at certain angle increments (for example, 90 degrees (4 sensors) or 60 degrees (6 sensors)). Each of the sensors installed on the circumference measures its distance to a wellbore wall. It allows for evaluating the tool center position relative to the well center and/or wellbore shape. Ranging is essentially achieved by measuring the time interval between the direct signal and the signal reflected from the object. There are three ranging methods that can be used, depending on what laser modulation is used in the sensor: pulse, phase or phase pulse (combination of the first two modulations). The fundamental principle of the pulse method is sending a sounding impulse to the wellbore wall, which starts time counter of the sensor. When the reflected impulse reaches the sensor, the time counter is stopped. The travel time (delay of the reflected impulse) is used to determine the distance to the object. If phase method is applied, laser is modulated by a sine wave with a modulator (an electrooptic crystal changing its properties under the effect of electric signal). Normally, 10-150 MHz (measurement frequency) sine wave is used for modulation. Reflected radiation travels to the receiving optical device and the photoelectric detector where the modulating signal is detected. Depending on the distance to the wellbore wall, reflected signal phase shifts relative to the phase of the signal in the modulator. The distance to the object is determined by measuring the phase shift.
iii. Information about the tool position is transmitted to a data processing module.
iv. The data processing module estimates the tool position and/or wellbore shape using a pre-defined database to determine a required signal emission direction by the directional dipole acoustic signal source. The database can be created in advance for a specific wellbore diameter and specific tool characteristics based on a numerical model, experimental data or analytical calculations. As an alternative, possible options may be computed by the data processing module based on data about current position, type of the logging tool, and any other data from any other types of sensors. The data processing module can be installed inside the logging tool or on a surface location, or it can consist of a combination of modules inside the logging tool and on the surface. A decision about the required signal direction is made on the basis of pre-defined information about what type of measurements should be conducted, i.e. what spectrum is required to be generated downhole. For example, as shown on FIG. 2 and FIG. 3, when a signal is emitted in different directions (directions 1 and 2), different spectra of oscillations are generated, with different dispersion curves. Dotted lines on FIG. 2 and FIG. 3—analytical dispersion curves for a wellbore without the logging tool (in all cases, the wellbore is assumed to be filled with fluid), solid lines—dispersion curves plotted for the eccentric logging tool (the result is obtained by numerical modeling).
v. The data processing module estimates an angle Ω between the current position of the dipole signal source (i.e. direction of its directional pattern) and the required direction of signal emission already found at the previous step (the current position of the source, or course, is defined based on the information received from the tool positioning sensors). The value of the rotation angle is sent to a rotating mechanism of section (1) of the tool which contains the source(s) (it can be a mechanical, a magnetic, or other device).
vi. The rotating mechanism turns the tool section with the signal source until the angle Ω is reached.
vii. The source emits the signal and the receiver (receivers) records the acoustic field, i.e. measurements are recorded.
viii. The cycle is repeated.

1. A method for acoustic logging, the method comprising:
disposing an acoustic logging tool in a wellbore, wherein the logging tool is configured to move within the wellbore and the logging tool comprises at least one source configured to emit directional acoustic signals and at least one receiver configured to receive acoustic signals;
determining at least one of (i) a position of the logging tool in the wellbore and (ii) a shape of the wellbore before performing acoustic measurements using the logging tool;
determining a direction for emission of the directional acoustic signals;
calculating an angle of rotation around an axis of the logging tool for the source to provide the direction for emission;
rotating the source by the calculated angle; and
performing acoustic measurements using the calculated angle.

2. The method of claim 1 wherein the position of the logging tool in the wellbore is determined on the basis of sensor measurements.

3. The method of claim 2 wherein the sensors are ultrasonic sensors.

4. The method of claim 2 wherein the sensors are optoelectronic sensors.

5. The method of claim 2 wherein the shape of the wellbore is determined on the basis of sensor measurements.

6. The method of claim 5 wherein the sensors are ultrasonic sensors.

7. The method of claim 5 wherein the sensors are optoelectronic sensors.

8. The method of claim 1, wherein the direction is a required direction.
